(19) United States
(12) Patent Application Publication
(10) Pub. No.: US 2026/0231022 A1
(43) Pub. Date: Aug. 6, 2026

(54) ACTIVATING AND DEACTIVATING SENSORS OF A TERMINAL DEVICE

(71) Applicant: SHARP KABUSHIKI KAISHA, Osaka (JP)

(72) Inventors: Kenneth James Park, ncouverVa, WA (US); Atsushi ISHII, Vancouver, WA (US); Rudraksh SHRIVASTAVA, Vancouver, WA (US)

(21) Appl. No.: 19/155,700

(22) PCT Filed: Feb. 22, 2024
(86) PCT No.: PCT/JP2024/006495

§ 371 Date: Aug. 12, 2025

Related U.S. Application Data
(60) Provisional application No. 63/492,747, filed on Mar. 28, 2023.

(51) Int. Cl. H04W 52/02

(52) U.S. Cl. CPC H04W 52/0216; H04W 52/0219; H04W 52/0229; H04W 52/0251; H04W 52/028

(57) ABSTRACT

A terminal device of a New Radio (NR) system and a corresponding method are provided. The method includes receiving, by RF reception circuitry of the terminal device, while the terminal device resides in an enabled state, a first command to transition to one of a plurality of disabled states in which the RF reception circuitry is enabled and RF transmission circuitry of the terminal device is disabled. The disabled states include a first disabled state in which one or more sensors of the terminal device are activated and are configured according to a first configuration; a second disabled state in which the one or more sensors are deactivated and are configured according to the first configuration; and a third disabled state in which the one or more sensors are deactivated and are configured according to the factory reset configuration.

### CROSS REFERENCE

This Nonprovisional application claims priority under 35 U.S.C. § 119 on provisional Application No. 63/492,747 on Jun. 27, 2023, the entire contents of which are hereby incorporated by reference.

### TECHNICAL FIELD

The present disclosure generally relates to wireless communications and, more specifically, to activating and deactivating sensors and/or associated processes of a terminal device (e.g., a User Equipment (UE) of a Fifth-Generation (5G) (e.g., New Radio (NR)) network).

### BACKGROUND ART

A fundamental use case for development of Third-Generation Partnership Project (3GPP) 5G technologies is known as Narrow-Band Internet of Things (NB-IoT)/Machine-Type Communication (MTC). (Two other fundamental use cases include Ultra-Reliable Low-Latency Communications (URLLC) and Enhanced Mobile Broadband (eMBB).)

NB-IoT is a standards-based low-power wide-area (LPWA) technology developed to enable a wide range of new (Internet of Things) IoT devices and services. NB-IoT significantly improves user device power consumption, system capacity, and spectrum efficiency, especially in deep coverage. Battery life of more than ten years may be supported for a wide range of use cases. For 3GPP NR, new physical layer signals and channels are designed to meet the demanding requirement of extended coverage (e.g., for rural and deep-indoor applications) and ultra-low device complexity. The initial cost of NB-IoT modules is expected to be a significant market driver for uptake of this technology, as the underlying technology may be much simpler than existing solutions and its cost is expected to decrease rapidly as demand increases.

MTC (also termed M2M (Machine-to-Machine)) denotes a broad area of wireless communication involving sensors, actuators, physical objects, and other devices not directly operated by humans. MTC denotes a data channel between two entities without the involvement of a human. This communication typically occurs between an MTC device and an MTC server, with a prime example being smart metering for utility services, such as gas, water, and electricity. MTC communication could also potentially occur between MTC devices without the involvement of an MTC server.

To facilitate this fundamental use case in some applications, “ambient-power-enabled Internet of Things” (ambient-power-enabled IoT or ambient-powered IoT) devices may be employed. An ambient-power-enabled IoT device possesses no battery and has no or limited energy storage capability (e.g., via use of a capacitor). Such a device may obtain its operating energy through the harvesting of radio waves, light, motion, heat, or any other suitable power source. An aspect of an ambient-power-enabled IoT device is that the device and/or portions thereof may be “enabled” or “disabled” (or “activated” and “deactivated”) to efficiently manage power consumption of the device.

As described in greater detail below, in employing NR to provide ambient-power-enabled IoT technology, further innovations to the NR system, such as communications between such a device and the network, may be desirable.

### SUMMARY OF INVENTION

In one of its example aspects the technology disclosed herein concerns a terminal device of a New Radio (NR) system that supports activation and deactivation of sensor operations. The terminal device includes: radio frequency (RF) transmission circuitry; RF reception circuitry; one or more sensors; one or more non-transitory computer-readable media storing a set of computer-executable instructions; and at least one processor coupled to the one or more non-transitory computer-readable media and configured to execute the set of computer-executable instructions to cause the terminal device to perform operations comprising: receiving, by the RF reception circuitry from a transmitting device, a first configuration for the one or more sensors; updating a factory reset configuration for the one or more sensors to the first configuration; receiving, by the RF reception circuitry from the transmitting device while the terminal device resides in an enabled state, a first command to transition to one of a plurality of disabled states; and transitioning, in response to receiving the first command, to the one of the plurality of disabled states, the plurality of disabled states comprising: a first disabled state in which the RF reception circuitry is enabled, the RF transmission circuitry is disabled, the one or more sensors are activated, and the one or more sensors are configured according to the first configuration; a second disabled state in which the RF reception circuitry is enabled, the RF transmission circuitry is disabled, the one or more sensors are deactivated, and the one or more sensors are configured according to the first configuration; and a third disabled state in which the RF reception circuitry is enabled, the RF transmission circuitry is disabled, the one or more sensors are deactivated, and the one or more sensors are configured according to the factory reset configuration.

### BRIEF DESCRIPTION OF DRAWINGS

Implementations of the present technology will now be described, by way of example only, with reference to the attached figures.

FIG. 1 Implementations of the present technology will now be described, by way of example only, with reference to the attached figures.

FIG. 2 is a state diagram illustrating states among which a terminal device may transition, according to an example implementation of the present disclosure.

FIG. 3 is a flowchart illustrating operations performed by a terminal device and an authorized transmitting device, according to an example implementation of the present disclosure.

FIG. 4 is a flowchart illustrating a method performed by a terminal device to transition to a DISABLED_FACTORY_RESET state, according to an example implementation of the present disclosure.

FIG. 5 is a flowchart illustrating a method performed by a terminal device to transition to an ENABLED state, according to an example implementation of the present disclosure.

FIG. 6 is a flowchart illustrating a method performed by a terminal device to transition to a DISABLED state, according to an example implementation of the present disclosure.

FIG. 7 is a flowchart illustrating a method performed by a terminal device to transition to a DISABLED_DEACTIVATED state, according to an example implementation of the present disclosure.

FIG. 8 is a messaging diagram illustrating a message flow among a UE (e.g., serving as an ambient-power-enabled IoT), a Next Generation NodeB (gNB), and a network entity using broadcast system information to facilitate state transitions of the UE, according to an example implementation of the present disclosure.

FIG. 9 is a messaging diagram illustrating a message flow among a UE, a gNB, and a network entity using dedicated signaling to facilitate state transitions of the UE, according to an example implementation of the present disclosure.

FIG. 10 is a messaging diagram illustrating a message flow among a UE, a gNB, and a network entity using dedicated signaling to facilitate state transitions of the UE, according to another example implementation of the present disclosure.

FIG. 11 is a block diagram illustrating a node for wireless communication, according to an example implementation of the present application.

### DESCRIPTION OF EMBODIMENTS

The 3GPP is a collaboration agreement that aims to define globally applicable technical specifications and technical reports for third and fourth generation wireless communication systems. The 3GPP may also define specifications for next-generation mobile networks, systems, and devices.

3GPP Long-Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), and other standards (e.g., 3GPP Releases (Rel) 8, 9, 10, 11, 12, 13, 14, 15, and so on) including New Radio (NR), which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., a public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices may include cellular phones, smart phones, personal digital assistants (PDAs), laptop computers, netbooks, e-readers, wireless modems, etc.

In the 3GPP specifications, a wireless communication device may typically be referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a NodeB, an evolved NodeB (eNB), a home enhanced or evolved NodeB (HeNB), a Next Generation NodeB (gNB), or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., a Local Area Network (LAN), the Internet, etc.) for wireless communication devices. The term “communication device” may be used to denote both a wireless communication device and/or a base station. An eNB and/or gNB may also be more generally referred to as a base station device.

It should be noted that, as used herein, a “cell” may be any communication channel that is specified by standardization or regulatory bodies to be used for International Mobile Telecommunications-Advanced (IMT-Advanced), and all of IMT-Advanced, or a subset thereof, may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed New Radio (NR) technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Therefore, the detailed description of the present disclosure as illustrated in the figures is not intended to limit the scope of the present disclosure but is merely representative of the systems and methods.

A basic discussion of some aspects of NR communication technology is provided below, followed by a more specific discussion relating to embodiments described in the present disclosure.

### NR System Information

System Information (SI) in NR includes a Master Information Block (MIB) and a number of System Information Blocks (SIBs), which are divided into Minimum SI and Other SI. Minimum SI carries basic information required for initial access and for acquiring any other SI. Minimum SI includes MIB and SIB1. For a UE to be allowed to camp on a cell, it may have acquired the contents of the Minimum SI from that cell. Other SI includes all SIBs not broadcast in the Minimum SI. The UE may not need to receive these SIBs before accessing the cell.

The MIB may provide for a System Frame Number (SFN), critical information for the reception of SIB1 (e.g., subcarrier spacing (SCS), subcarrier offset, Demodulation Reference Signal (DMRS) position, and/or PDCCH configuration), a cell barred flag, and/or an intra-frequency reselection allowed flag. The MIB may be mapped on to a Broadcast Control Channel (BCCH) logical channel and may be carried on a Broadcast Channel (BCH) transport channel. The BCH is then mapped onto a Physical Broadcast Channel (PBCH).

The MIB may be transmitted with a periodicity of 80 milliseconds (ms) and may be repeated (according to Synchronization Signal Block (SSB) periodicity) within the 80 ms. MIB contents may be the same over the 80 ms period, and the same MIB may be transmitted over all SSBs within the Synchronization Signal (SS) burst set. The MIB may provide the UE with parameters (e.g., Control Resource Set #0 (CORESET #0) configuration) required to acquire SIB1 (e.g., more specifically, information useful for monitoring of a PDCCH for scheduling a PDSCH that carries SIB1).

SIB1 may provide cell selection information, a Public Land Mobile Network (PLMN) list, cell ID, tracking area code, RAN area code, cell reserved flag, connection establishment failure control information, SI scheduling information, serving cell common uplink and downlink configurations (e.g., configuration information for a Random Access Channel (RACH), paging, etc.), Supplementary UL (SUL) configuration, SSB scheduling information, cell-specific Time-Division Duplex (TDD) UL/DL configurations, a cell's Internet Protocol (IP) Multimedia Subsystem (IMS) emergency bearer support flag (e.g., for UEs in limited service), emergency call over IMS support flag, a UE's timers and constants, access control information, etc.

The SIB1 may carry the most critical information required for the UE to access the cell (e.g., random access parameters). The SIB1 may include information regarding the availability and scheduling of other SIBs (e.g., mapping of SIBs to SI message, periodicity, SI window size, etc.). SIB1 may also indicate whether one or more SIBs are only provided on-demand, in which case SIB1 may also provide a PRACH configuration needed by the UE to request the required SI. The SIB1 may be transmitted on the Downlink Shared Channel (DL-SCH (e.g., a logical channel—BCCH)) with a periodicity of 160 ms and variable transmission repetition periodicity within 160 ms. The SIB1 may be a cell-specific SIB.

The UE may acquire the SI upon cell selection (e.g., upon power on), cell reselection, return from out of coverage, after reconfiguration with synchronization completion, after entering the network from another Radio Access Technology (RAT), upon receiving an indication that the SI has changed, upon receiving a PWS (Public Warning System) notification, and/or whenever the UE does not have a valid version of a stored SIB.

### Support of Ultra-Low-Power Applications

For Rel-19, the 3GPP Service and System Aspects (SA) Working Group 1 (SA1) conducted a Stage-1-level study (e.g., an overall service description) regarding the support of ultra-low-power applications, where the power requirements of such a device may be satisfied via local energy harvesting by the device (e.g., in which no battery is required by the device, as sufficient operating energy may be derived from the local environment and used either immediately, or stored in a capacitor for later use). The SA1 Stage 1 study was concluded in December 2022, with the results captured in Technical Report (TR) 22.840 v1.0.0 . The study covered use cases, traffic scenarios, and device constraints of ambient-power-enabled IoT devices and identified new potential service requirements, as well as new key performance indicators (KPIs), related to 3GPP NR-type devices, access networks, and core networks.

The study was preceded by an agreement in SA1 of a Work Item Description (WID) document. That document provides the justification for the work and an outline of the scope of the work that is expected to take place with respect to developing the TR. The latest revision of the WID can be found in SP-220085.

As discussed in the justification section of the WID, mMTC is an important use case for 5G. However, other important use cases and scenarios are not adequately covered by Rel-18 technologies:
1) Device with ultra-low complexity
2) Device with a very small size/form factor (e.g., thickness of a millimeter (mm))
3) Device that is maintenance-free (e.g., no need to replace a conventional battery)
4) Device with a long lifecycle
5) Device deployed where a conventional battery is not applicable

To address at least the use cases listed above, SA1 agreed to a study on IoT service using an IoT device powered by energy harvesting (in other words, an ambient-power-enabled IoT device), where a device powered by such energy harvesting can support IoT communications without relying on a conventional power source and/or avoids human intervention for recharging or replacing. In addition to the low power consumption of such an ambient-power-enabled IoT device, the study also considers low device complexity, small device size, and a device with a long lifecycle.

Typically, an ambient-power-enabled IoT device doesn't use a conventional battery. Such a device is capable of harvesting, storing, and subsequently using, or harvesting and immediately using, energy from wireless radio waves or any other form of energy that can be locally obtained to meet the needs of a particular use case. For example, in some scenarios, an ambient-power-enabled IoT device can harvest energy from radio waves, where the radio waves may come from 5G NR network entities (e.g., a gNB or a Customer Premise Equipment (CPE)) or User Equipment (UE) (e.g., a handheld device or another IoT device). In some other scenarios, an ambient-power-enabled IoT device may harvest energy from solar energy, motion/vibration, heat, pressure, or any other potential energy differential.

Some of the potential challenges for ambient-power-enabled IoT technology include:
1) An extremely-low-complexity device form factor
2) An ability to harvest energy and at the same time use the harvested energy to support communication
3) A capability to provide sufficient communication services to fulfil the corresponding requirements
4) A capability to provide user privacy
5) A capability to provide data security

In many use cases, the lifecycle of an ambient-power-enabled IoT device should be properly managed to meet user and institutional expectations. For example, a device may be commanded by a 5G system (5GS) to enter an “enabled” or “disabled” state. More specifically, a device that is in an enabled state can use both its RF transmitter and RF receiver for two-way communications (e.g., transmit and receive) with the 5GS, while a device that is in a disabled state can use only its RF receiver for one-way communications (e.g., receive only) from the 5GS. Thus, by using “enabled” or “disabled” commands, the network time & frequency resources and the device's overall energy usage may be optimized to meet user expectations.

In another example, an ambient-power-enabled IoT device may be configured with sensors for the monitoring of the immediate environment (e.g., temperature, pressure, humidity, etc.) of the device. When such a device is used to monitor environmental conditions, the environmental monitoring capabilities of the device may be intended to be activated only during certain periods of time (e.g., during a product manufacturing process). Further, when the environmental monitoring capabilities of the device are not required, the sensors associated with monitoring functions of the device may be deactivated and placed in a low-power or “off” state to reduce the overall energy usage of the device. Thus, such an ambient-power-enabled IoT device may be commanded by the 5GS to “activate” or “deactivate” the operations of specific sensors on the device.

Moreover, in some examples, when the device is placed into a “disabled” state to disable its RF transmitter, the other power-consuming activities of the device may also be disabled, thus possibly employing a single command to disable the transmitter and deactivate one or more sensors of the device.

In Section 17 of TR 22.840, a “Use Case on Device Activation and Deactivation” (referred to herein as Use Case 5.17) is captured. This use case identifies the need to not only enable and disable an ambient-power-enabled IoT device (e.g., an ambient IoT with environmental sensors), but also the need to activate and deactivate the sensors and/or associated processes of the device.

More specifically, when an ambient-power-enabled IoT device is initially deployed (e.g., at the beginning of its intended use), the device may initially be in an operational state of “disabled” and may require the reception of an Enable command to trigger a change of state of the device to an operational state of “enabled”. When the device is in the operational state of “enabled”, the device may establish a communications channel with the 5GS, whereby the device may receive, from the 5GS, configuration data, operational commands, and parameters. The device may also transmit data to the 5GS that may include data, commands, and parameters.

When the device is in an operational state of “Enabled” and has established a communications channel with the 5GS, the 5GS may further provide commands to the device to begin one or more processes to begin its intended function (e.g., to obtain information about the device's immediate environmental conditions).

To begin such a process, or set of processes, the 5GS may send to the device one or more activation commands to trigger processes of the device to enter a working state. Such a process may be associated with a specific sensor (e.g., a pressure sensor), or may be associated with a set of sensors (e.g., a pressure sensor, a temperature sensor, a humidity sensor, etc.) that are used to obtain information about the local environmental conditions of the device.

When a process is in a working state, the one or more sensors associated with the process are configured such that the sensors require the consumption of energy, as such energy is needed by the sensors to detect changes in the physical, chemical, or biological quantity of its local environment and convert the data it receives through this detection into an electrical signal.

For purposes of the present disclosure, the term “sensor” may indicate a functional element of an ambient-power-enabled IoT device that is used by the device to obtain information about its immediate (local) environmental conditions. However, a transducer is also a type of device that can be used to obtain information about environmental conditions. While technical differences may exist between a sensor and a transducer, for purposes of the present disclosure, we consider sensors, transducers, and/or both may be employed by the device to obtain information about the device's immediate environmental conditions. Therefore, the term “sensor” in this disclosure is intended to also include the functionality of a transducer in as much as a sensor and a transducer both require energy to function to obtain information about the device's immediate environmental conditions.

When the 5GS has determined one or more processes operating on the device have completed their intended functions (e.g., to obtain information about the device's immediate environmental conditions), the 5GS may transmit to the device one or more deactivation commands to trigger the processes to enter a non-working state. In the non-working state, a process is considered to be in a state in which the one or more sensors associated with that process are configured to consume considerably less, and possibly no, energy as compared to when the process is in a working state, as the sensors of the process are not detecting changes in the physical, chemical, or biological quantities exhibited by the local environment. Additionally, the 5GS may optionally send to the device a command to reset the device to a factory default configuration, and thus clear any data obtained by the sensors and any configuration data and parameters stored on the device that were obtained from the 5GS.

Following the transmission of a deactivation command and optionally the factory reset command to the device, the 5GS may determine that the operation of the device is not needed and may send the device a disable command that may trigger the device to transition from an operational state of “enabled” to an operational state of “disabled” upon the receipt of the disable command.

Thus, in some examples, the device may perform the following operations:
1) The transmitter is disabled while the device is not in use.
2) The transmitter is enabled prior to its intended use.
3) The device is configured with operational parameters.
4) The sensors are activated.
5) The sensors are deactivated.
6) The operational parameters are reset to factory default.
7) The transmitter is disabled while the device is not in use.

However, based on iterations of the operations listed above steps (e.g., restarting at the second operation after finishing the last operation, as the first and last operation are the same), some operations may be unnecessary. For example, following each operation to deactivate the sensors, the device may execute an operation to disable the device for when the device is not in use. Thus, the operations and control of the device may be managed by the 5GS to not require some operations based on the deployment and usage of the particular device. Consequently, an opportunity may exist to optimize the use of system time and frequency resources and the consumption of device power.

Moreover, as described above, the initial and ending operational states of the device are the same state of “disabled” with respect to the device's ability to establish a communication channel with the 5GS. As such, a device that is in the disabled state following the end of its intended use may terminate communications with the 5GS and can subsequently be triggered to change to its state to “enabled” and again establish communications with the 5GS.

As noted in Requirement 5.17.6 of TR 22.840, the 5G system may provide means for an authorized user or authorized third parties to request enabling and disabling an ambient IoT device capability to transmit RF signals. From this requirement, an ambient-power-enabled IoT device, defined therein, is configurable for two states: “enabled” and “disabled”.

For an ambient-power-enabled IoT device in the enabled state, the device may be able to use its RF reception circuitry to receive RF energy for the purposes of (1) harvesting RF energy so that it may be stored in a capacitor for later use to power the operations of the device, or used immediately to power the operations of the device and (2) decoding information that may be encoded on the RF waveform, where the information may include commands from a transmitting device related to the operation of the IoT device or data from a transmitting device related to the configuration of the IoT device.

Furthermore, an ambient-power-enabled IoT device that is in the enabled state may be triggered to use its RF transmission circuitry to transmit an RF energy waveform that has information encoded thereupon, where the information may include commands for execution by another device that are related to the operation of the ambient-power-enabled IoT device, and/or may include data from the device to another device that is related to the operation of the device. The source of such a trigger may be from a process that is internal to the device (e.g., the expiration of a timer) or external to the device (e.g., a command received by the device via a received and decoded RF waveform).

For an ambient-power-enabled IoT device in the disabled state, the device is able to use its RF reception circuitry to receive RF energy for the purpose of (1) harvesting RF energy so that it may be stored into a capacitor for later use to power the operations of the device, or used immediately to power the operations of the device except for operations of the device that include the transmission of an RF waveform, and (2) decoding information that maybe encoded on the RF waveform, where the information may include commands from a transmitting device related to the operation of the device or data from a transmitting device related to the configuration of the device.

Furthermore, an ambient power-enabled IoT device that is in the disabled state may be triggered to change from the disabled state to the enabled state such that the device may then use its RF transmission circuitry to transmit an RF energy waveform that has information encoded thereupon, where the information may include commands for execution by another device that are related to the operation of the ambient-power-enabled IoT device, or may include data from the device related to the operation of the device. In some implementations, the source of such a trigger may be from a process that is external to the device (e.g., a command received by the device via a received and decoded RF waveform), and not from a process that is internal to the device (e.g., the expiration of a timer).

Thus, Requirement 5.17.6 of TR 22.840 provides that the device shall be able to receive a command that either (1) changes the state of the device from “disabled” (not able to transmit RF signals, but able to receive and decode RF signals) to “enabled” (able to transmit RF signals, and able to receive and decode RF signals) or (2) changes the state of the device from “enabled” to “disabled”.

Also, in Requirement 5.1.6 of TR 22.840, “The 5G system shall support procedures for Ambient IoT control and user data transmission; to use a minimum number of transactions with the Ambient IoT device.” Based on this requirement, an ambient-power-enabled IoT device and the system supporting the device may be designed such that communications between the device and the system are optimal with respect to the use of both communication protocol resources and RF resources.

For an ambient-power-enabled IoT device in the enabled state, the device may utilize its RF reception circuitry to receive RF energy for the purposes of (1) harvesting RF energy for storage in a capacitor for later use to power the operations of the device, or consumed immediately to power the operations of the device, and (2) decoding information that may be encoded on the RF waveform, where the information may include commands, from a transmitting device, that are related to the operation or configuration of the device.

Additionally, an ambient-power-enabled IoT device that is in the Enabled state may use its RF reception circuitry to receive multiple different commands from the transmitting device related to the operation of one or more processes of the device that may control the operations of one or more different sensors of the device.

From the above discussion, a first requirement for an ambient-power-enabled IoT device, as presented in TR 22.840, indicates that before the start of the device operational lifecycle, and at the end of the device operational lifecycle, the device should be in a disabled state in which it cannot transmit RF energy, and during the device operational lifecycle, the device should be capable of changing between a state of “enabled”, in which the device can transmit RF energy, and a state of “disabled”, in which the device cannot transmit RF energy. As such, the device can be commanded to change its state from “disabled” to “enabled” and back to “disabled” multiple times, where such a command may be transmitted by a gNB or other authorized transmitting device and is received, decoded, and acted upon by the device. In some implementations, the disabled state may be viewed as a desired lower-power state relative to the enabled state due to the lack of transmission capability associated with the disabled state.

According to a second requirement, the 5GS may support the triggering of ambient-power-enabled IoT devices to perform specific actions, and the 5G System may allow an operator to provision, authenticate, authorize, and perform other operations relative to the device. Further, according to a third requirement, the 5GS may support procedures for ambient-power-enabled IoT control and user data transmission by employing a minimum number of transactions with the device.

Accordingly, some conflict may exist between the three general requirements in that multiple commands may be employed by the 5GS for the control and operations of the device, and that there a need exists to minimize the number of such commands transmitted to the device. Thus, optimizing communication between the 5GS and the device may be desirable.

No method or command is currently defined in the 3GPP NR protocol to trigger a specific device identified by a device-specific and unique serial number (or a group of specific devices associated with a group serial number) to change from a state of “enabled” or “disabled” to a state of “disabled” and to deactivate all processes of the device to deactivated. As such, multiple commands are typically employed to place a device that is currently in the enabled or disabled state with active processes into a disabled state with all processes deactivated such that the processes are configured into a low power consumption state.

Moreover, no method or command is currently defined in the 3GPP NR protocol to trigger a specific device as identified by a device-specific and unique serial number (or a group of specific devices associated with a group serial number) to change from a state of “enabled” or “disabled” to a state of “disabled” and return all processes and configurations of the device into a “factory reset” state. As such, multiple commands are typically employed to place a device that is currently in the enabled or disabled state with active processes into a disabled state with all processes and configuration in the factory reset state.

### Support for a DISABLED_DEACTIVATED State and a DISABLED_FACTORY_RESET State

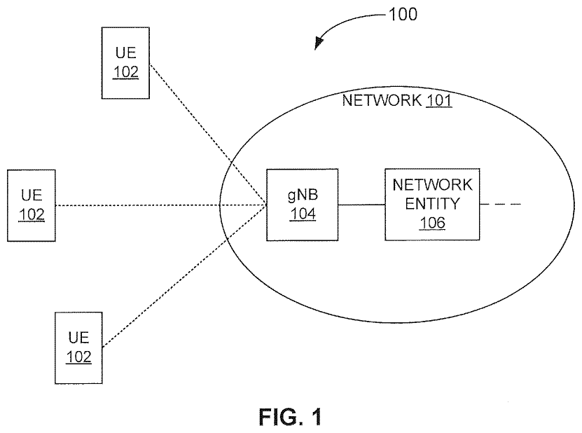

FIG. 1 is a block diagram illustrating a communication system 100 including a plurality of terminal devices (e.g., UEs 102 serving as ambient-power-enabled IoTs) in communication with an associated network 101, according to an example implementation of the present disclosure. While three UEs 102 are depicted in FIG. 1, fewer or greater numbers of UEs 102 may be included in communication system 100 in other examples. In some implementations, each UE 102 may be identified with a UE-specific serial number (e.g., stored in nonvolatile read-only memory, such as at the time of manufacture of UE 102). Also, in some implementations, one or more UEs 102 may form an ambient-power-enabled IoT group that is identified with a serial number corresponding to the group (e.g., stored in a rewritable nonvolatile memory).

Network 101 may communicate with UEs 102 by way of a base station (e.g., a gNB 104) included therein. In some implementations, gNB 104 may be communicatively coupled with a network entity 106. Examples of network entity 106 may include, but are not limited to, a server or node in a core network (CN) (e.g., an Access and Mobility Management Function (AMF)) or a server resident in a private/public network.

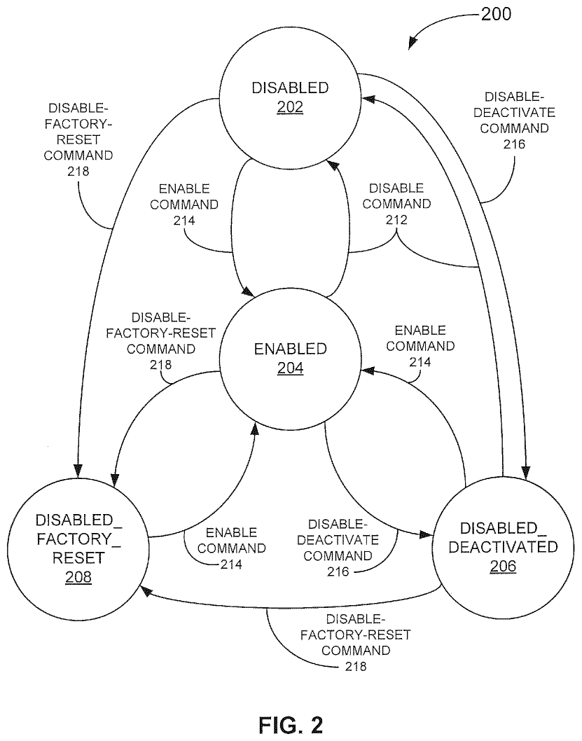

FIG. 2 is a state diagram 200 illustrating states among which a terminal device (e.g., UE 102 of FIG. 1) may transition, according to an example implementation of the present disclosure. As shown in FIG. 2, the states may include a DISABLED state 202, an ENABLED state 204, a DISABLED_DEACTIVATED state 206, and a DISABLED_FACTORY_RESET state 208.

In some implementations, while in the DISABLED state 202, the terminal device may be able to receive signals (e.g., the RF receiving circuitry of the terminal device is enabled to receive signals from an authorized transmitting device), but may be unable to transmit signals (e.g., the RF transmitting circuitry of the terminal device is disabled from transmitting signals). In addition, in some implementations, one or more sensors of the terminal device that are currently active (e.g., powered on) may remain active, and on-board memory storing one or more sensor configurations (e.g., configurations received from an authorized transmitting device (e.g., gNB 104 of FIG. 1) may remain on and accessible. Accordingly, any processes on the device that currently operate the one or more sensors may continue to function.

In the ENABLED state 204, in some implementations, the terminal device may be able to both receive and transmit signals (e.g., the RF receiving and transmitting circuitry of the terminal device may be enabled). In addition, in some implementations, as with the DISABLED state 202, the currently active one or more sensors of the terminal device may remain active, and on-board memory storing the one or more sensor configurations from an authorized transmitting device may remain on and accessible. Consequently, any processes on the device that currently operate the one or more sensors may continue to function.

In some implementations, in the DISABLED_DEACTIVATED state 206, the terminal device may be able to receive signals (e.g., the RF receiving circuitry of the terminal device is enabled to receive signals from an authorized transmitting device), but may be unable to transmit signals (e.g., the RF transmitting circuitry of the terminal device is disabled from transmitting signals), and on-board memory continued to store any sensor configurations previously received from an authorized transmitting device, as is the case in the DISABLED state 202. However, unlike in the DISABLED state 202, all of the one or more sensors and of the terminal device may be deactivated (e.g., powered off or in a low-energy state), and their associated processes may be inoperative, in the DISABLED_DEACTIVATED state 206.

In the DISABLED_FACTORY_RESET state 208, in some implementations, the terminal device may be able to receive signals (e.g., the RF receiving circuitry of the terminal device is enabled to receive signals from an authorized transmitting device), but may be unable to transmit signals (e.g., the RF transmitting circuitry of the terminal device is disabled from transmitting signals), and all sensors of the terminal device may be deactivated (powered off), and their associated processes may be in-operative, as in the DISABLED_DEACTIVATED state 206. However, unlike in the DISABLED_DEACTIVATED state 206, the on-board memory, including the sensor configurations associated with the sensors of terminal device, may be returned to a “factory reset” or “factory default” state. For example, in such a state, the on-board memory (e.g., non-volatile memory) may carry default configurations for the sensors, as well as other default configuration data provided in the terminal device at the time of manufacture of the device. In addition, any sensor configuration data or other configuration data received from an authorized transmitting device and stored by the terminal device may be deleted or erased.

The terminal device may transition among states 202, 204, 206, and 208 in response to commands executed by the terminal device that are received from an authorized transmitting device (e.g., gNB 104 of FIG. 1). In some examples, the commands may be provided to the gNB by way of another system (e.g., network entity 106 of FIG. 1), which may be in communication with an authorized user (e.g., an owner or manager of UEs 102). In some implementations, the terminal device may execute such commands in response to another event or stimulus detected by the terminal device and/or originating within the terminal device, such as the completion of a sensing/measurement cycle or process using the one or more sensors of the terminal device, the detection of a one or more conditions, the expiration of a timer, and so on. As illustrated in FIG. 2, the commands may include a Disable command 212, an Enable command 214, a Disable-Deactivate command 216, and a Disable-Factory-Reset command 218, in which each command, when executed by the receiving terminal device, may cause a transition of the terminal device to a corresponding state.

For example, in some implementations, the terminal device may receive, from a gNB or other authorized transmission device, a command that is specific to the device, or specific to a group to which the device belongs, where the command enables the device to begin a sensing/measurement cycle or process such that when the process completes, it may result in an internally generated “self-deactivation command” that triggers the device to transition from the ENABLED state 204 to the DISABLED state 202, the DISABLED_DEACTIVATED state 206, or the DISABLED_FACTORY_RESET STATE 208 based on the sensor and/or process configuration stored in the on-board memory of the terminal device.

In some implementations, the 5GS (e.g., by way of configuration data provided to the terminal device) may further define a linkage between a process and the one or more sensors of the device in terms of which of the one or more sensors that a sensing process or cycle may use to determine if the process shall generate a self-deactivation command that triggers the device to transition from the ENABLED state 204 to the DISABLED state 202, the DISABLED_DEACTIVATED state 206, or the DISABLED_FACTORY RESET STATE 208. For example, if a device has temperature, pressure, and humidity sensors, the 5GS may individually control and configure the process to use the data from one or more of those sensors based on the sensor and/or process configurations provided by the 5GS to the terminal device.

Further, in some implementations, the 5GS may further define a linkage between a process and the one or more sensors of the device in terms of the metrics used by the process when evaluating the data provided by the sensors that are linked to the process. For example, the 5GS may individually control and configure the process with metrics that define how many measurement cycles a sensor shall provide to the process to determine if the process shall generate a self-deactivation command that triggers the device to transition from the ENABLED state 204 to the DISABLED state 202, the DISABLED_DEACTIVATED state 206, or the DISABLED_FACTORY_RESET STATE 208, where the sensing measurement cycle maybe different for each individual sensor.

Additionally, in some implementations, a process associated with one or more sensors may be factory-configured or may be configured by the 5GS to track one or more sets of metrics, whereby when one or more metrics tracked by the process exceed or more thresholds that are also factory-configured or configured by the 5GS, the process may determine whether the process generates a self-deactivation command that triggers the device to transition from the ENABLED state 204 to the DISABLED state 202, the DISABLED_DEACTIVATED state 206, or the DISABLED_FACTORY_RESET STATE 208. A non-limiting example of such an individual metric may be the passing of an amount of time, a number of sensor measurements, a particular quality of the sensor measurements, or the sensor measurement values. A non-limiting example of such a combination of metrics may be the time and sensor measurement values, the time and sensing cycles, the sensing cycles and quality of sensor measurements, or any combination of individual metrics.

In some implementations, the terminal device may initially reside in the DISABLED_FACTORY_RESET state 208 at the time that the manufacturing of the terminal device is complete. In that state, the terminal device may be able to receive signals but be unable to transmit signals. Thereafter, an authorized transmitting device may transmit an Enable command 214 that, when received and executed by the terminal device, may cause the terminal device to enable its transmitting circuitry, thus allowing the terminal device to transmit and receive signals. One or more authorized transmitting devices, during the lifecycle of the terminal device, may then transmit any number of Disable commands 212 and Enable commands 214 that, when received and executed by the terminal device, may alternatively place the terminal device in the DISABLED state 202 and the ENABLED state 204, according to the needs of the system or the authorized user. For example, the terminal device may be placed temporarily in the DISABLED state 202 during time periods when the terminal device is to reduce its power consumption to some lower level, (e.g., due to the lack of signal transmission by the terminal device in that state) while still allowing the terminal device to operate its sensors to collect data regarding the local environment.

Additionally, in some implementations, when the terminal device is in either the DISABLED state 202 and the ENABLED state 204, the terminal device may receive a Disable-Deactivate command 216 or a Disable-Factory-Reset command 218 from an authorized transmitting device to transition the terminal device to the DISABLED_DEACTIVATED state 206 or the DISABLED_FACTORY_RESET state 208, respectively. For example, at times when the terminal device is to be substantially inactive or dormant (e.g., by way of the RF transmission circuitry and all sensors being deactivated) to achieve and exceptionally low-power state, the terminal device may be placed in either the DISABLED_DEACTIVATED state 206 or the DISABLED_FACTORY_RESET state 208 to reduce power consumption. Furthermore, the terminal device may receive an Enable command 214, a Disable command 212, or a Disable-Factory-Reset command 218 to transition the terminal device to the ENABLED state 204, the DISABLED state 202, or the DISABLED_FACTORY_RESET state 208, respectively.

In some implementations, when the terminal device is in the DISABLED_FACTORY_RESET state 208, the terminal device may only transition to the ENABLED state 204 (e.g., upon receiving an Enable command 214 from an authorized transmitting device).

In some implementations, the ambient-power-enabled IoT feature set may facilitate the ability of the terminal device such that following the reception by the device from an authorized transmitting device of a state transition command (e.g., an Enable command 214, a Disable command 212, a Disable-Deactivate command 216, or a Disable-Factory-Reset command 218) to change the state of the terminal device, the device may transmit to the transmitting device an acknowledgement message, where the acknowledgement message may indicate reception of the state transition command.

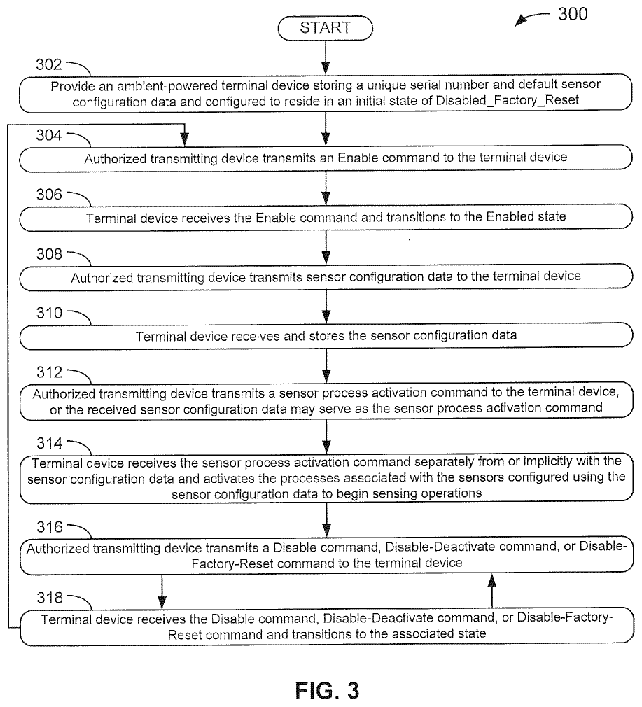

FIG. 3 is a flowchart illustrating operations 300 performed by a terminal device and an authorized transmitting device, according to an example implementation of the present disclosure. As indicated above, in some implementations, the terminal device may be an ambient-power-enabled IoT device, and the authorized transmitting device may be a gNB or base station device that provides the functionality ascribed thereto, as discussed herein. While the operations depicted in FIG. 3 are presented in a particular order, other orders of execution for the operations are also possible. Also, while a particular set of operations are presented in FIG. 3, greater or fewer operations than that shown may be included in other implementations.

In operation 302, a terminal device is provided that may store (e.g., in read-only non-volatile memory, such as Read-Only Memory (ROM)) a unique serial number identifying the device (e.g., a serial number that is unique among all potentially constructed ambient-power-enabled IoT devices), and that is configured to reside in an initial state of a DISABLED FACTORY RESET state (e.g., DISABLED_FACTORY_RESET state 208). In some implementations, while in the initial DISABLED state, the terminal device may not be provisioned with any configuration and/or operational data (e.g., sensor configuration data). Thereafter, in operation 304, the authorized transmitting device may transmit an Enable command (e.g., Enable command 214). In some implementations, the Disable command and/or other commands described herein may be transmitted by the authorized transmitting device via one or more signaling methods, including, but not limited to, broadcast system information and dedicated signaling. In response, in operation 306, the terminal device may receive and execute the Enable command to transition to an ENABLED state (e.g., ENABLED state 204).

While the terminal device is in the ENABLED state, the authorized transmitting device, in operation 308, may transmit user configuration and/or operational data to the terminal device. In some implementations, the configuration data may include a serial number associated with a group identity (e.g., a group of similar devices of which the terminal device is a member). In response, in operation 310, the terminal device may receive and store the user configuration and/or operational data (e.g., sensor configuration data, such as in a writable nonvolatile memory). In some examples, the sensor configuration data may include configuration for one or more sensors that are included in the terminal device.

In operation 312, the authorized transmitting device may transmit a sensor process activation command to the terminal device. In other implementations, the previously transmitted sensor configuration data (e.g., in operation 308) may serve as the sensor process activation command. In response, in operation 314, the terminal device may receive the sensor process activation command (or, as indicated above, the previously received sensor configuration data may serve as the sensor process activation command). The sensor process activation command, when executed by the terminal device, may activate a process that uses one or more of the configured sensors to sense an immediate environment within which the terminal device is located.

In operation 316, the authorized transmitting device may transmit one of one or more possible commands that “disable” the terminal device. In some implementations, such commands may include a Disable command (e.g., Disable command 212), a Disable Deactivate command (e.g., Disable-Deactivate command 216), and a Disable Factory Reset command (e.g., Disable-Factory-Reset command 218), as described above. Accordingly, in operation 318, the terminal device may receive the Disable command (e.g., based on the serial number or the group identity stored in the terminal device) and transition to the corresponding disabled state (e.g., DISABLED state 202, DISABLED_DEACTIVATED state 206, or DISABLED_FACTORY_RESET state 208, as described above). In other examples, as described above, the terminal device may execute a self-deactivate command based on the sensor and/or process configuration stored in the on-board memory of the terminal device that triggers the device to transition to a particular one of the disabled states.

In some implementations, an authorized transmitting device may transmit additional Enable and Disable commands during the lifecycle of the terminal device (e.g., as indicated in operations 304 and 318 and as shown in FIG. 2), and the terminal device may execute the commands to perform the corresponding state transitions and associated operations (e.g., as indicated in operations 306 and 316).

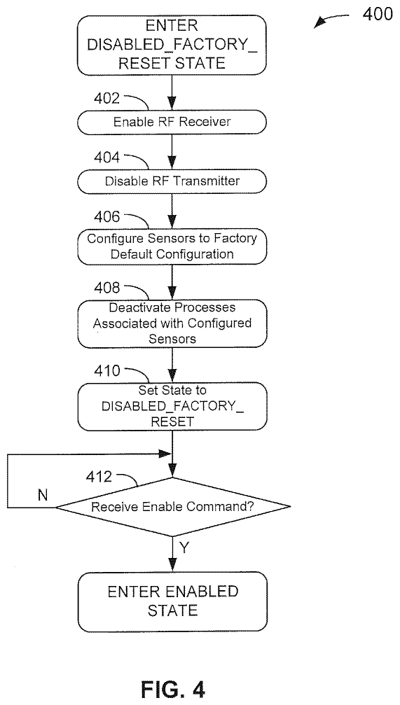

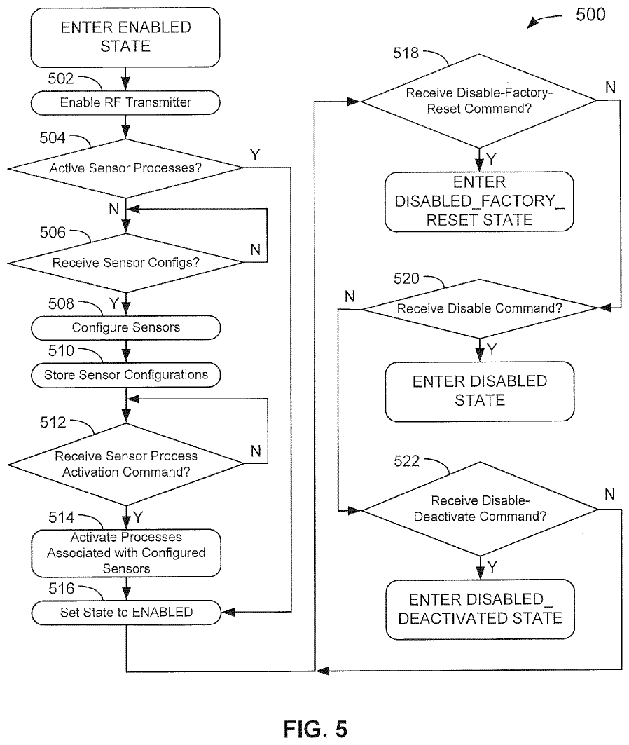

FIG. 4 is a flowchart illustrating a method 400 performed by a terminal device for transition to the DISABLED_FACTORY_RESET state 208, according to an example implementation of the present disclosure. While the operations depicted in FIG. 4 (as well as the operations FIGS. 5-7, described further below) are presented in a particular order, other orders of execution for the operations are also possible. Also, while a particular set of operations are presented in FIGS. 4-7, greater or fewer operations than that shown may be included in other implementations.

In the method 400 of FIG. 4, the terminal device (e.g., UE 102 of FIG. 1 serving as an ambient-power-enabled IoT device) may enable its RF receiver in operation 402 and disable its RF transmitter in operation 404. The terminal device may also configure at least one or more of its sensors to a factory default configuration in operation 406, which may be stored in a non-volatile on-board memory during manufacturing of the terminal device. The terminal device may also deactivate all processes associated with the sensors, as configured in the factory default configuration, in operation 408. The terminal device may also set its current state to the DISABLED_FACTORY RESET state 208 in operation 410.

While in the DISABLED_FACTORY_RESET state 208, the terminal device may then determine whether an Enable command (e.g., Enable command 214 of FIG. 2) is received in operation 412 (e.g., from an authorized transmitting device). If the Enable command is received in operation 412, the terminal device may execute a method for entering the ENABLED state 204, as illustrated in FIG. 5.

Accordingly, FIG. 5 is a flowchart illustrating a method 500 performed by the terminal device to transition to the ENABLED state 204, according to an example implementation of the present disclosure. In the method 500, the terminal device may enable its RF transmitter in operation 502. The terminal device may then determine whether there are active sensor processes currently operating in the terminal device in operation 504. If so, the terminal device may proceed directly to transitioning to the ENABLED state 204 in operation 516. Otherwise, if there are no active sensor processes currently operating, the terminal device may then await the reception of one or more sensor configurations from an authorized transmitting device in operation 506, configure the sensors according to the sensor configurations in operation 510, and store the received sensor configurations (e.g., in an onboard memory, such as a non-volatile memory) in operation 510. The terminal device may then await reception of a sensor process activation command in operation 512. In other implementations, the received one or more sensor configurations may also serve as the sensor process activation command. The terminal device may then activate one or more processes associated with the configured sensors to being sensing or monitoring environmental conditions in the immediate area of the terminal device in operation 514, and transition to the ENABLED state 204 in operation 516.

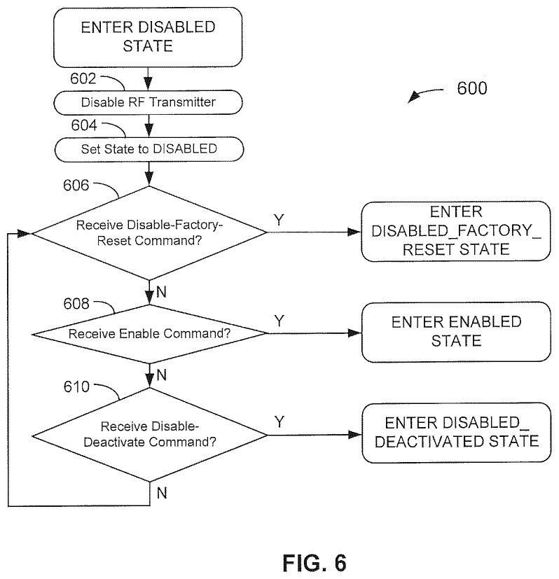

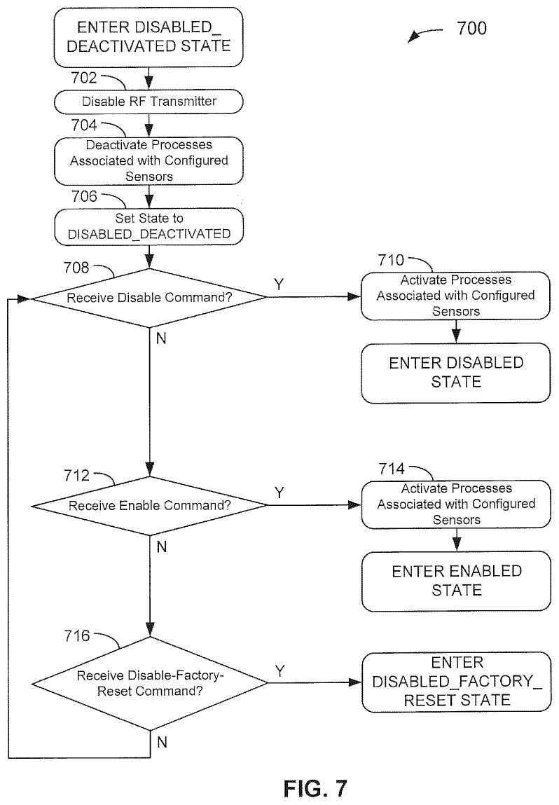

When in the ENABLED state 204, the terminal device may await reception of a command to transition to one of the disabled states described above. For example, the terminal device may await reception of the Disable-Factory-Reset command 218 in operation 518, the Disable command 212 in operation 520, and/or the Disable-Deactivate command 216 in operation 522, and, if received, may execute a method for transitioning to the corresponding state (e.g., method 400 of FIG. 4 for the Disable-Factory-Reset command 218 to transition to the DISABLED_FACTORY RESET state 208, a method shown in FIG. 6 for the Disable command 212 to transition to the DISABLED state 202, or a method depicted in FIG. 7 for the Disable-Deactivate command 216 to transition to the DISABLED_DEACTIVATED state 206).

FIG. 6 is a flowchart illustrating a method 600 performed by a terminal device to transition to the DISABLED state 202, according to an example implementation of the present disclosure. In the method 600, the terminal device may disable its RF transmitter in operation 602 and set its state to the DISABLED state 202 in operation 604. Consequently, in some implementations, the processes employing the sensors of the terminal device may continue to operate while placing the RF transmitter into a low-power state.

While in the DISABLED state 202, the terminal device may then await reception of a command to transition to another one of the states of FIG. 2. For example, the terminal device may await reception of the Disable-Factory-Reset command 218 in operation 606, the Enable command 214 in operation 608, and/or the Disable-Deactivate command 216 in operation 610, and, if received, may execute a method for transitioning to the corresponding state (e.g., method 400 of FIG. 4 for the Disable-Factory-Reset command 218 to transition to the DISABLED_FACTORY RESET state 208, method 500 shown in FIG. 5 for the Enable command 214 to transition to the ENABLED state 204, or a method depicted in FIG. 7 for the Disable-Deactivate command 216 to transition to the DISABLED_DEACTIVATED state 206).

FIG. 7 is a flowchart illustrating a method 700 performed by a terminal device to transition to the DISABLED_DEACTIVATED state 206, according to an example implementation of the present disclosure. In the method 700, the terminal device may disable the RF transmitter in operation 702, configure the one or more sensors of the terminal device according to the default or factory reset configuration in operation 704, deactivate all processes associated with the configured sensors in operation 706, and transition to the DISABLED_DEACTIVATED state 206.

In some implementations, while in the DISABLED_DEACTIVATED state 206, the terminal device may then await reception of a command to transition to another one of the states of FIG. 2. For example, the terminal device may await reception the Disable command 212 in operation 710, the Enable command 214 in operation 716, and/or the Disable-Factory-Reset command 218 in operation 718. If the Disable command 212 is received in operation 710, the terminal device may configure the one or more sensors of the terminal device according to the current configuration provided in the on-board memory in operation 712, activate the one or more processes associated with the configured sensors in operation 714, and execute method 600 of FIG. 6 to transition to the DISABLED state 202. Instead, if the terminal device receives the Enable command 214 in operation 716 or the Disable-Deactivate command 216 in operation 718, the terminal device may execute a method for transitioning to the corresponding state (e.g., method 500 shown in FIG. 5 for the Enable command 214 to transition to the ENABLED state 204 or method 400 of FIG. 4 for the Disable-Factory-Reset command 218 to transition to the DISABLED_FACTORY_RESET state 208).

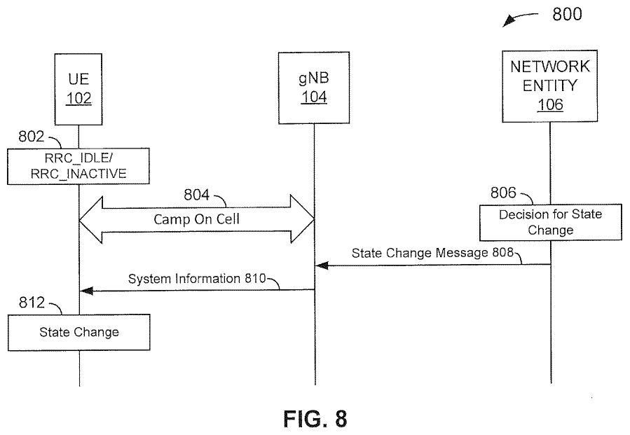

FIG. 8 is a messaging diagram illustrating a message flow 800 among a UE 102 (e.g., serving as an ambient-power-enabled IoT), a Next Generation NodeB (gNB) 104, and a network entity 106 using broadcast system information to facilitate state transitions of UE 102, according to an example implementation of the present disclosure. In some implementations, network entity 106 may be a server or node in a core network (e.g., an AMF), a server resident in a private/public network, or the like.

In the message flow 800, UE 102 may be in a Radio Resource Control (RRC)_IDLE or RRC_INACTIVE state 802, during which UE 102 may camp on a cell served by gNB 104 in operation 804. During this time, in operation 806, network entity 106 may decide to change the state of UE 102 (e.g., change to one of states 202-208 of FIG. 2), as well as that of possibly other UEs. In response to the decision, network entity 106 may broadcast a state change message 808 to inform gNB 104 of the decision. State change message 808 may include one or more state change commands (e.g., one of commands 212-216 of FIG. 2). State change message 808 may include one or more UE-specific identifiers (IDs) (e.g., serial numbers) corresponding to UE 102 and other UEs to which the state change is to be applied. In some implementations, additionally or alternatively, state change message 808 may include one or more device group IDs, where each of the device group IDs identifies a corresponding group of UEs, and where UE 102 is a member of one of the device groups.

In response to receiving state change message 808, gNB 104 may broadcast the contents or indications of state change message 808 in system information 810, such as one or more SIBs. In response to receiving system information 810, UE 102 may determine whether system information 810 includes an indication of a state change command associated with the UE-specific ID of UE 102 or a group ID for a group that includes UE 102. If system information 810 includes such a state change command, UE 102 may execute the state change command to facilitate a state change 812 (e.g., to one of the states 202-208 of FIG. 2).

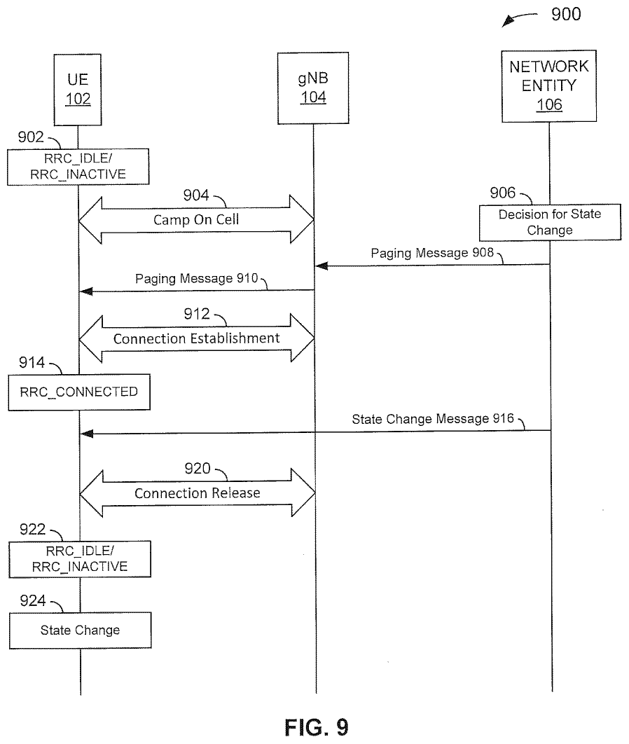

FIG. 9 is a messaging diagram illustrating a message flow 900 among UE 102, gNB 104, and network entity 106 using dedicated signaling to facilitate state transitions of UE 102, according to an example implementation of the present disclosure. The initial portions of message flow 900 may be at least similar to that of message flow 800 of FIG. 8. More specifically, in the message flow 900, UE 102 may be in an RRC_IDLE or RRC_INACTIVE state 902, during which UE 102 may camp on a cell served by gNB 104 in operation 904. During this time, in operation 906, network entity 106 may decide to change the state of UE 102 (e.g., change to one of states 202-208 of FIG. 2), as well as possibly the state of other UEs.

Thereafter, network entity 106 may send a paging message 908 to gNB 104 that includes the UE-specific device ID of UE 102 and/or a group ID applicable to UE 102. In response, gNB 104 may forward paging message 908 as paging message 910 to UE 102. Upon receiving paging message 910, UE 102 may initiate a connection establishment procedure 912 to establish an RRC connection with gNB 104. Once connection establishment procedure 912 is complete, UE 102 may enter an RRC_CONNECTED state 914 with gNB 104. While UE 102 is in the RRC_CONNECTED state 914, network entity 106 may transmit a state change message 916 (e.g., one of commands 212-216 of FIG. 2) via gNB 104 specifically to UE 102. In some implementations, state change message 916 may be a Non-Access Stratum (NAS) message. Additionally or alternatively, state change message 916 may be a user plane message (e.g., including one or more Internet Protocol (IP) packets).

After UE 102 receives state change message 916, in some implementations, gNB 104 may initiate a connection release procedure 920, thus causing UE 102 to enter the RRC_IDLE or RRC_INACTIVE state 922. Thereafter, UE 102 may perform the state change command received in state change message 916 to facilitate a state change 924.

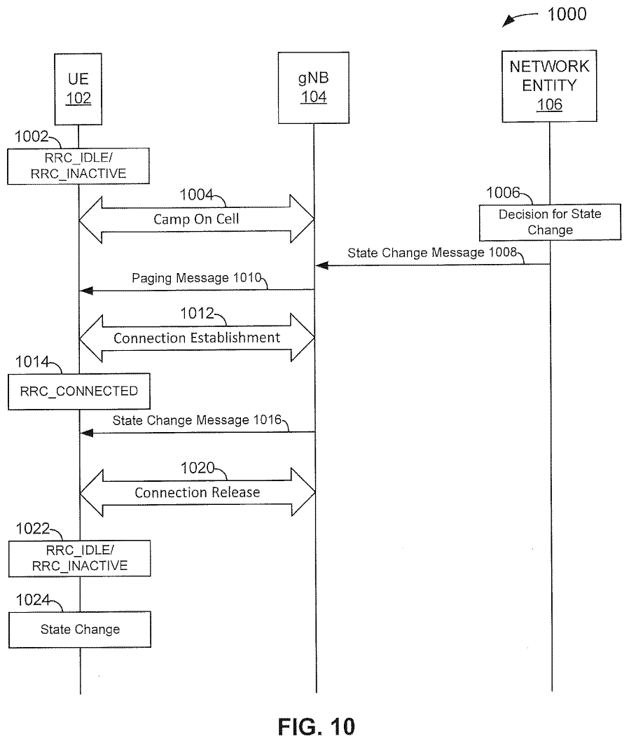

FIG. 10 is a messaging diagram illustrating a message flow 1000 among UE 102, gNB 104, and network entity 106 using dedicated signaling to facilitate state transitions of UE 102, according to another example implementation of the present disclosure. The initial portions of message flow 1000 may be at least similar to that of message flow 800 of FIG. 8. More specifically, in the message flow 1000, UE 102 may be in an RRC_IDLE or RRC_INACTIVE state 1002, during which UE 102 may camp on a cell served by gNB 104 in operation 1004. During this time, in operation 1006, network entity 106 may decide to change the state of UE 102 (e.g., change to one of states 202-208 of FIG. 2), as well as possibly the states of other UEs.

Thereafter, network entity 106 may send a state change message 1008 to gNB 104 that includes a state change command (e.g., one of commands 212-216 of FIG. 2), as well as the UE-specific device ID of UE 102 and/or a group ID applicable to UE 102. In response, gNB 104 may transmit a paging message 1010 to UE 102. Upon receiving paging message 1010, UE 102 may initiate a connection establishment procedure 1012 to establish an RRC connection with gNB 104. Once connection establishment procedure 1012 is complete, UE 102 may enter an RRC_CONNECTED state 1014 with gNB 104. While UE 102 is in the RRC_CONNECTED state 1014, gNB 104 may transmit a state change message 1016 via gNB 104 specifically to UE 102. In some implementations, state change message 1016 may include the state change command indicated in state change message 1008, along with the corresponding UE-specific ID or group ID for UE 102. In some implementations, state change message 1016 may be an RRC message (e.g., an RRCReconfiguration message).

After transmitting state change message 1016, gNB 104 may initiate a connection release procedure 1020, thus causing UE 102 to enter the RRC_IDLE or RRC_INACTIVE state 1022. Thereafter, UE 102 may perform the state change command received in state change message 1016 to facilitate a state change 1024.

As described above, an ambient-power-enabled IoT device may receive, from a gNB or other authorized transmission device, a state change command that is specific to the device, or specific to a group to which the device belongs. Depending on the state change command received, as described above, execution of the command by the ambient-power-enabled IoT device may (1) enable or disable the device RF transmit circuitry, (2) power off or on any sensors that are active or inactive (e.g., by deactivating the associated one or more processes employing those sensors), and (3) maintaining or erasing sensor configuration data and/or sensor operation data, thus efficiently controlling the operation and associated energy usage of the device.

Moreover, the various state change commands described herein (e.g., Enable command 214, Disable command 212, Disable-Deactivate command 216, and/or Disable-Factory-Reset command 218 of FIG. 2) may be transmitted by a gNB or other authorized transmission device in one or more signaling methods. Such signaling methods may include, but are not limited to, broadcast system information and dedicated signaling.

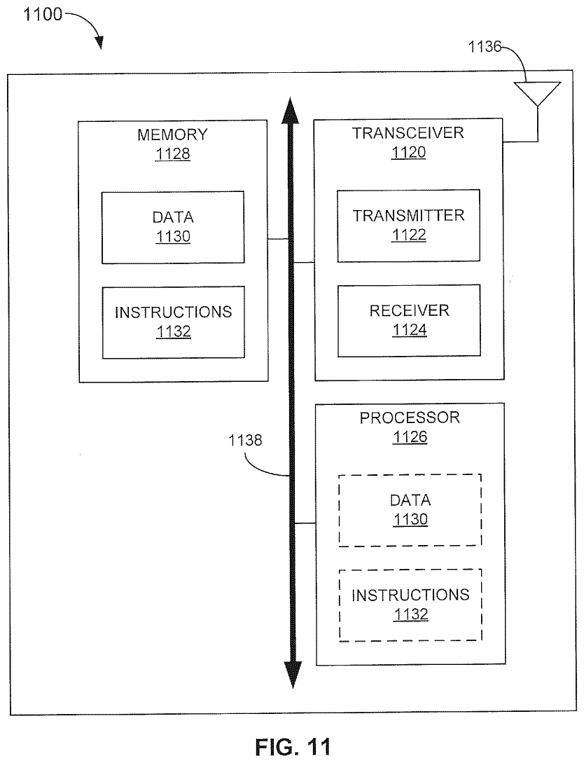

FIG. 11 illustrates a block diagram of a node for wireless communication, according to one example implementation of the present application. As shown in FIG. 11, node 1100 may include transceiver 1120, processor 1126, memory 1128, and at least one antenna 1136. Node 1100 may also include a radio frequency (RF) spectrum band module, a base station communications module, a network communications module, and a system communications management module, input/output (I/O) ports, I/O components, and power supply (not explicitly shown in FIG. 11). Each of these components may be in communication with each other, directly or indirectly, over one or more buses 1140.

Transceiver 1120 having transmitter 1122 and receiver 1124 may be configured to transmit and/or receive time and/or frequency resource partitioning information. In some implementations, transceiver 1120 may be configured to transmit in different types of subframes and slots including, but not limited to, usable, non-usable, and flexibly usable subframes and slot formats. Transceiver 1120 may be configured to receive data and control signaling.

Node 1100 may include a variety of computer-readable media. Computer-readable media can be any available media that can be accessed by node 1100 and include both volatile and nonvolatile media, removable and nonremovable media. By way of example, and not limitation, computer-readable media may include computer storage media and communication media. Computer storage media may include both volatile and nonvolatile, removable and nonremovable media implemented in any method or technology for storage of information, such as computer-readable instructions, data structures, program modules, or other data.

Computer storage media include random-access memory (RAM), read-only memory (ROM), electrically erasable programmable read-only memory (EEPROM), flash memory, or other memory technology, compact disc read-only memory (CD-ROM), digital versatile disk (DVD), or other optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

Memory 1128 may include computer-storage media in the form of volatile and/or nonvolatile memory. Memory 1128 may be removable, nonremovable, or a combination thereof. Exemplary memory includes solid-state memory, hard drives, optical-disc drives, etc. As illustrated in FIG. 11, memory 1128 may store computer-readable, computer-executable instructions 1132 (e.g., software codes) that are configured to, when executed, cause processor 1126 to perform various functions described herein, for example, with reference to FIGS. 1 through 10. Alternatively, instructions 1132 may not be directly executable by processor 1126 but be configured to cause node 1100 (e.g., when compiled and executed) to perform various functions described herein.

Processor 1126 may include an intelligent hardware device, for example, a central processing unit (CPU), a microcontroller, an application-specific integrated circuit (ASIC), etc. Processor 1126 may include memory. Processor 1126 may process data 1130 and instructions 1132 received from memory 1128, and information through transceiver 1120, the baseband communications module, and/or the network communications module. Processor 1126 may also process information to be sent to transceiver 1120 for transmission through antenna 1136, to the network communications module for transmission to a core network.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

In one example, a terminal device of a New Radio (NR) system that supports activation and deactivation of sensor operations, the terminal device comprising: radio frequency (RF) transmission circuitry; RF reception circuitry; one or more sensors; one or more non-transitory computer-readable media storing a set of computer-executable instructions; and at least one processor coupled to the one or more non-transitory computer-readable media and configured to execute the set of computer-executable instructions to cause the terminal device to perform operations comprising: receiving, by the RF reception circuitry from a transmitting device, a first configuration for the one or more sensors; updating a factory reset configuration for the one or more sensors to the first configuration; receiving, by the RF reception circuitry from the transmitting device while the terminal device resides in an enabled state, a first command to transition to one of a plurality of disabled states; and transitioning, in response to receiving the first command, to the one of the plurality of disabled states, the plurality of disabled states comprising: a first disabled state in which the RF reception circuitry is enabled, the RF transmission circuitry is disabled, the one or more sensors are activated, and the one or more sensors are configured according to the first configuration; a second disabled state in which the RF reception circuitry is enabled, the RF transmission circuitry is disabled, the one or more sensors are deactivated, and the one or more sensors are configured according to the first configuration; and a third disabled state in which the RF reception circuitry is enabled, the RF transmission circuitry is disabled, the one or more sensors are deactivated, and the one or more sensors are configured according to the factory reset configuration.

In one example, the terminal device, wherein: in the enabled state, the RF transmission circuitry and the RF reception circuitry are enabled, and the one or more sensors are activated.

In one example, the terminal device, the operations further comprising: receiving, by the RF reception circuitry from the transmitting device while the terminal device resides in the first disabled state, a second command to transition to the second disabled state; and transitioning, in response to receiving the second command, to the second disabled state.

In one example, the terminal device, the operations further comprising: receiving, by the RF reception circuitry from the transmitting device while the terminal device resides in the second disabled state, a second command to transition to the first disabled state; and transitioning, in response to receiving the second command, to the first disabled state.

In one example, the terminal device, the operations further comprising: receiving, by the RF reception circuitry from the transmitting device while the terminal device resides in the first disabled state, a second command to transition to the third disabled state; and transitioning, in response to receiving the second command, to the third disabled state.

In one example, the terminal device, the operations further comprising: receiving, by the RF reception circuitry from the transmitting device while the terminal device resides in the first disabled state, the second disabled state, or the third disabled state, a second command to transition to the enabled state; and transitioning, in response to receiving the second command, to the enabled state.

In one example, the terminal device, wherein the terminal device is prohibited from transitioning directly from the third disabled state to the first disabled state or the second disabled state.

In one example, the terminal device, wherein: the terminal device comprises an ambient-power-enabled Internet-of-Things (IoT) device.

In one example, the terminal device, wherein: the transmitting device comprises a base station.

In one example, the terminal device, further comprising: a non-volatile read-only memory storing the factory reset configuration.

In one example, the terminal device 1, further comprising: a nonvolatile read-only memory storing a device identifier (ID) for the terminal device, wherein: the device ID is unique among a plurality of terminal devices that includes the terminal device; and the first command includes an indication of the device ID.

In one example, the terminal device, further comprising a nonvolatile memory, wherein the operations further comprise: receiving, from the transmitting device, a group identifier (ID) associated with a plurality of terminal devices that includes the terminal device, wherein the first command includes an indication of the group ID; and storing, in the nonvolatile memory, the group ID.

In one example, the terminal device, wherein: the first command is received from a base station while the terminal device is in a Radio Resource Control (RRC)_IDLE state or an RRC_INACTIVE state and camped on the base station.

In one example, the terminal device, wherein: the first command is received in at least one system information block (SIB) transmitted by the base station.

In one example, the terminal device, wherein: the first command is received from a base station while the terminal device is in a Radio Resource Control (RRC) CONNECTED state with the base station.

In one example, the terminal device, wherein: the first command is received in an RRC message transmitted by the base station.

In one example, the terminal device, wherein: the RRC message comprises an RRCReconfiguration message.

In one example, the terminal device, wherein: the first command is received in a Non-Access Stratum (NAS) message transmitted by the base station.

In one example, a method performed by a terminal device of a New Radio (NR) system that supports activation and deactivation of sensor operations, the method comprising: receiving, by RF reception circuitry from a transmitting device, a first configuration for one or more sensors of the terminal device; updating a factory reset configuration for the one or more sensors to the first configuration; receiving, by the RF reception circuitry from the transmitting device while the terminal device resides in an enabled state, a first command to transition to one of a plurality of disabled states; and transitioning, in response to receiving the first command, to the one of the plurality of disabled states, the plurality of disabled states comprising: a first disabled state in which the RF reception circuitry is enabled, RF transmission circuitry of the terminal device is disabled, the one or more sensors are activated, and the one or more sensors are configured according to the first configuration; a second disabled state in which the RF reception circuitry is enabled, the RF transmission circuitry is disabled, the one or more sensors are deactivated, and the one or more sensors are configured according to the first configuration; and a third disabled state in which the RF reception circuitry is enabled, the RF transmission circuitry is disabled, the one or more sensors are deactivated, and the one or more sensors are configured according to the factory reset configuration.

In one example, A transmitting device of a New Radio (NR) system that supports activation and deactivation of sensor operations, the transmitting device comprising: radio frequency (RF) transmission circuitry; one or more non-transitory computer-readable media storing a set of computer-executable instructions; and at least one processor coupled to the one or more non-transitory computer-readable media and configured to execute the set of computer-executable instructions to cause the transmitting device to perform operations comprising: transmitting, by the RF transmission circuitry to a terminal device in an enabled state, a first configuration for one or more sensors of the terminal device, wherein the terminal device, in response to receiving the first configuration by RF reception circuitry of the terminal device, updates a factory reset configuration for the one or more sensors to the first configuration; and transmitting, by the RF transmission circuitry to the terminal device in the enabled state, a first command to transition to one of a plurality of disabled states, wherein the terminal device in the enabled state, in response to the receiving the first command by the RF reception circuitry, transitions to the one of the plurality of disabled states, the plurality of disabled states comprising: a first disabled state in which the RF reception circuitry is enabled, RF transmission circuitry of the terminal device is disabled, the one or more sensors are activated, and the one or more sensors are configured according to the first configuration; a second disabled state in which the RF reception circuitry is enabled, the RF transmission circuitry of the terminal device is disabled, the one or more sensors are deactivated, and the one or more sensors are configured according to the first configuration; and a third disabled state in which the RF reception circuitry is enabled, the RF transmission circuitry of the terminal device is disabled, the one or more sensors are deactivated, and the one or more sensors are configured according to the factory reset configuration.

1. A terminal device of a New Radio (NR) system that supports activation and deactivation of sensor operations, the terminal device comprising:
radio frequency (RF) transmission circuitry;
RF reception circuitry;
one or more sensors;
one or more non-transitory computer-readable media storing a set of computer-executable instructions; and
at least one processor coupled to the one or more non-transitory computer-readable media and configured to execute the set of computer-executable instructions to cause the terminal device to perform operations comprising:
receiving, by the RF reception circuitry from a transmitting device, a first configuration for the one or more sensors;
updating a factory reset configuration for the one or more sensors to the first configuration;
receiving, by the RF reception circuitry from the transmitting device while the terminal device resides in an enabled state, a first command to transition to one of a plurality of disabled states; and
transitioning, in response to receiving the first command, to the one of the plurality of disabled states, the plurality of disabled states comprising:
a first disabled state in which the RF reception circuitry is enabled, the RF transmission circuitry is disabled, the one or more sensors are activated, and the one or more sensors are configured according to the first configuration;
a second disabled state in which the RF reception circuitry is enabled, the RF transmission circuitry is disabled, the one or more sensors are deactivated, and the one or more sensors are configured according to the first configuration; and
a third disabled state in which the RF reception circuitry is enabled, the RF transmission circuitry is disabled, the one or more sensors are de-activated, and the one or more sensors are configured according to the factory reset configuration.

2. The terminal device of claim 1, wherein:
in the enabled state, the RF transmission circuitry and the RF reception circuitry are enabled, and the one or more sensors are activated.

3. The terminal device of claim 1, the operations further comprising:
receiving, by the RF reception circuitry from the transmitting device while the terminal device resides in the first disabled state, a second command to transition to the second disabled state; and
transitioning, in response to receiving the second command, to the second disabled state.

4. The terminal device of claim 1, the operations further comprising:
receiving, by the RF reception circuitry from the transmitting device while the terminal device resides in the second disabled state, a second command to transition to the first disabled state; and
transitioning, in response to receiving the second command, to the first disabled state.

5. The terminal device of claim 1, the operations further comprising:
receiving, by the RF reception circuitry from the transmitting device while the terminal device resides in the first disabled state, a second command to transition to the third disabled state; and
transitioning, in response to receiving the second command, to the third disabled state.

6. The terminal device of claim 1, the operations further comprising:
receiving, by the RF reception circuitry from the transmitting device while the terminal device resides in the first disabled state, the second disabled state, or the third disabled state, a second command to transition to the enabled state; and
transitioning, in response to receiving the second command, to the enabled state.

7. The terminal device of claim 1, wherein:
the terminal device comprises an ambient-power-enabled Internet-of-Things (IoT) device.

8. The terminal device of claim 1, further comprising:
a non-volatile read-only memory storing the factory reset configuration.

9. The terminal device of claim 1, further comprising:
a nonvolatile read-only memory storing a device identifier (ID) for the terminal device, wherein:
the device ID is unique among a plurality of terminal devices that includes the terminal device; and
the first command includes an indication of the device ID.

10. The terminal device of claim 1, further comprising a nonvolatile memory, wherein the operations further comprise:
receiving, from the transmitting device, a group identifier (ID) associated with a plurality of terminal devices that includes the terminal device, wherein the first command includes an indication of the group ID; and
storing, in the nonvolatile memory, the group ID.

11. The terminal device of claim 1, wherein:
the first command is received from a base station while the terminal device is in a Radio Resource Control (RRC)_IDLE state or an RRC_INACTIVE state and camped on the base station.

12. The terminal device of claim 11, wherein:
the first command is received in at least one system information block (SIB) transmitted by the base station.

13. The terminal device of claim 1, wherein:
the first command is received from a base station while the terminal device is in a Radio Resource Control (RRC)_CONNECTED state with the base station.

14. The terminal device of claim 13, wherein:
the first command is received in an RRC message transmitted by the base station.

15. The terminal device of claim 14, wherein:
the RRC message comprises an RRCReconfiguration message.
